(19) United States
(12) Patent Application Publication
(10) Pub. No.: US 2018/0064097 A1
(43) Pub. Date: Mar. 8, 2018

(54) METHOD FOR HUNTING BLIND WITH ENLARGED ACCESS AND FORCE GENERATING STRUCTURE

(71) Applicant: New Archery Products, LLC, Forest Park, IL (US)

(72) Inventor: Jason N. Nolz, Manchester, IA (US)

(21) Appl. No.: 15/699,491

(22) Filed: Sep. 8, 2017

Related U.S. Application Data
(60) Provisional application No. 62/495,278, filed on Sep. 8, 2016.

(51) Int. Cl. A01M 31/02; E04H 15/00; E04H 15/34; E04H 15/64

(52) U.S. Cl. CPC A01M 31/025; E04H 15/64; E04H 15/34; E04H 15/001

(57) ABSTRACT

A method and apparatus for constructing a blind structure, such as a hunting blind. Two or more hub structures are formed, each with a hub and at least one and preferably four rods or support arms. The two hub structures are connected together. An expandable joint, such as an extension rod or extension arm, is positioned and connected so that each hub structure forces a hub to contact a corresponding panel. It is possible to force the panel into a concave orientation, such as in an outward direction from an interior to an outside of the blind structure.

### CROSS REFERENCE TO RELATED APPLICATIONS

This patent application claims priority under 35 USC Sec. 119 and/or 120 from co-pending U.S. Provisional patent application having Ser. No. 62/495,278, filed on 8 Sep. 2016. The entire disclosure of U.S. Provisional Patent Application 62/495,278 is incorporated in its entirety into this specification by reference thereto.

### BACKGROUND OF THE INVENTION

### Field of the Invention

This invention relates to an apparatus and method for strengthening hubs, increasing hub convexity, increasing stability, increasing a doorway size, adding a sidewall, providing asymmetry, and adjusting a size of a hub of a hunting blind, for example.

### Discussion of Related Art

Ground blinds are used in hunting or nature situations to watch or to provide shelter and concealment from the outdoors. Many different styles of ground blinds exist. This invention relates to hub style ground blinds. A hub is typically constructed of 4 flexible rods but others may contain 5 rods. The rods attach to a central bracket or hub with a hinge mechanism. The rods swing from the hubs to a folded position and to an open position. The hub and rods are attached to a flexible fabric cover using hardware in a center and rod pockets at a periphery. One single hub has 4 fiberglass rods, a central hub component and a fabric covering. These hubs are attached to one another or to additional panels to create an entire closed structure which is known as a ground blind.

Hub type ground blinds are typically made from 2 to 6 hubs that are attached to one another. The hubs have a pre-set amount of tension built into them. This tension is limited by the mechanism that allows the hub to work. This tension often gets weaker due to the fabric stretching over a time period. There is a need for an apparatus and a method for providing more convexity and strength in the hubs, so that when the fabric gets weak, the hubs continue to function.

Hub blinds have a symmetrical shape as they stand vertically or straight up and down in their silhouette shape and many have a predictable triangular shape between individual panels from all sides. In the outdoor world or natural world, this shape is detected as unnatural and animals often detect the blinds and run off or become frightened when the animals see them. Hunters counteract this effect by leaving blinds in the field so animals get accustomed to the blinds which often results in the blinds being stolen. There is a need for a hub hunting blind that allows for an adjustable asymmetrical shape and that more closely represents trees and bushes as they appear in nature or naturally.

Conventional 2-hub blinds are made from 2 hubs that lean or rest upon one another to form a classic A-frame structure or appearance. The hubs act as side walls and are sewn together at a top border. The triangular shaped panels in the front and the back act as a doorway and the back wall. If the front and back doorway or wall panels were not intact, the 2 hubs would hinge at the top at any angle and if desired could be laid flat on the ground. Stability is created by the 2 hubs being separated by a great enough distance so that gravity keeps them spaced apart. This desired position allows for a back or rear panel to be made to prevent further hinging and a front door panel to match the back or rear panel. This structure has no mechanism or structure to keep the 2 hubs apart, other than gravity. Stakes at the 4 corners could function to keep the halves separated and the rear panel and front door panel taut. Accessory supports or tubes or rods could be used to wedge the 2 hubs apart, but no mechanism exists to allow it to remain or stay square in the corners and to avoid collapse without staking the blind. If this type of blind was blown by wind on its side it would fold flat. Nothing keeps a conventional blind in its rectangular or square position.

### SUMMARY OF THE INVENTION

A blind according to this invention can generate internal or inside out forces applied to or implemented on a single side of the blind and physically and forcefully load internal forces against all sides and all corners of the entire blind structure, and can also provide or create a larger blind by having an additional wall while generating internal forces that push out against an entire outer cover and can store energy beyond the capabilities of the fabric cover.

Individual hub complexes work by the flexible fabric cover pushing inward while the rods and hubs push outward, for example. They require that every hub maintain its internal integrity or the entire structure fails. Hubs are sewn to bordering hubs in a total enclosed box structure. The 4 side hubs and roof hub form a complete box. All other applications of hub blinds including 2, 3 and 4 hub blinds lack the ability to stand on their own or roll, such as end over end, without collapsing.

Designs using hubs that have additional panels including front door or rear panels do not exist where an internal force is generating them to be taut with using an expansion rod at a single side. A contortion of the hubs past or beyond its relaxed implemented state represents stored energy and provides a dynamic force that changes with conditions. When wind blows the forces become greater. Forces against accessory panels cause panels of non-loaded blinds to weaken the entire structure where forces against accessory panels further compress hubs and tighten the exterior cover.

Hubs are limited by sizes because the individual rods lack the strength for the hubs to stay deployed when they become longer. The ability to increase overall convexity in the hub after the hub is deployed allows for using larger rod sizes than conventional models or designs. The ability to increase flexion of a rod, past or beyond its hub mechanism, demonstrates the increased forces generated by a blind according to this invention.

This invention provides a hub style or type of ground blind using a swing arm at an opening generally referred to as a doorway of the blind. Expansion rods attached to or near the bottom open corner of the hubs at the rod pocket act on the bottom rod and force it out against the opposing 2 attached or fixed sides. The swing arms attach to the adjacent rods in a folded position. The rods can be optionally deployed to produce an extra wall, and thus enlarge or increase a size or dimension of the blind, to tighten the external cover of the blind, to increase the strength of the individual hubs and to have force generated throughout the entire structure. The force creates a transformation from a symmetrical structure to an asymmetrical shaped structure and thus adds a wall and provides or creates more useable space by maintaining more convexity in the individual hubs while loading from a single side.

In one embodiment of this invention, a ground blind includes 2 hubs. The 2-hub blind can be or has an ability to be “loaded” by the swing arms and to create a 3 to 4 sided structure that is forcefully pushed or held into an open position and thus the structure could roll, such as end over end, like a ball and would stay deployed or open.

In another embodiment of this invention, a 2-hub blind includes a central zipper. The zipper from the doorway to the rear panel of the blind allows for the blind to open to a 5-panel loaded structure for concealment. The blind allows for a rapid opening of the roof which gets or provides stored energy through opposing hub contortion. The blind also optionally opens into a 5-sided shield where the swing alms act to provide support for the fourth and fifth walls. Also, the ability to open the blind up fully to form a wall in front of the hunter is yet another configuration of the blind according to this invention.

Another embodiment of this invention has a 3-hub blind arrangement. The three hubs can be joined end to end to form a triangle or triangular shape. In some embodiments of this invention, the roof has no hub and is triangular shaped. The swing arm or arms are attached at, near or to the interior corners at or near the doorway opening via mating rod pockets. When the blind stands or is deployed without using the swing arms, the blind has a straight vertical position and 3 sides which, for example, are useful for gun hunting. When the swing arms are deployed, they contort the blind into a sloped position and the individual hubs assume an asymmetrical hyper-convex shape, such as more desired by an archer that needs to swing or move an archery bow from side to side in a more rounded structure. This invention provides a ground blind constructed of 3 individual hubs and a door panel, that create more convexity in the huh, thus more strength in the hub and longer life to the blind structure.

Some embodiments of this invention provide a 2-hub blind with 3 to 4 sides and have the entire structure loaded forcefully allowing for the entire structure to stay deployed and fabric taught without using stakes.

Some embodiments of this invention provide a 3-hub ground blind that assumes a vertical symmetrical position with three sides and optionally enlarge the blind by providing or creating an additional wall and providing a 4-sided asymmetrical shaped blind. Some embodiments of this invention provide a 3-hub and 4-sided blind with a front door of greater distance across than the opposite hub or rear hub. Some embodiments of this invention provide a 3-hub blind with a roof panel that allows for more convexity and asymmetry to the adjacent top panels.

These and other objectives of this invention are better understood when the technical features of this invention are viewed in light of the following specification and the drawings.

### BRIEF DESCRIPTION OF THE DRAWINGS

FIG. 1 is a side view of a prior art 4-rod hub in a semi-folded position;

FIG. 2 is a top inside view of a prior art 4-rod hub complex;

FIG. 3 is a side view of a prior art 4-rod hub complex in a deployed position;

FIG. 4 is a side perspective view of a deployed prior art 4-rod hub complex;

FIG. 5 is a side view of a 4-rod hub complex, in a folded position, with an accessory rod attachment to an adjacent rod by way of an adjoining rod pocket, according to one embodiment of this invention;

FIG. 6 is a top view of a relatively flat 2-hub blind with expansion rods, according to one embodiment of this invention;

FIG. 7A is a side view of a 2-hub blind without front door panels in a deployed, relaxed upright position, according to one embodiment of this invention;

FIG. 7B is a front view of an expansion rods attachment, in a disassembled position, according to one embodiment of this invention;

FIG. 7C is a front view of an expansion rods attachment, in an assembled position, according to one embodiment of this invention;

FIG. 8A is a side skeleton view of a right hub complex without an accessory expansion rod deployed, according to one embodiment of this invention;

FIG. 8B is a side skeleton view of an asymmetrical right hub complex with an expansion rod deployed, according to one embodiment of this invention;

FIG. 9 is a front view of a 2-hub blind in a loaded position with expansion rods deployed;

FIG. 10 is a front view of the blind as shown in FIG. 9, with a front snap hook released and front door panels connected to rods preventing a release of tension, according to one embodiment of this invention;

FIG. 11 is a front view of a 2-hub blind with rested or relaxed fabric panels and expansion rods rested or relaxed, according to one embodiment of this invention;

FIG. 12A is a front view of a 3-hub blind with expansion rods deployed and a front door panel present but without a zipper for demonstration purposes, according to one embodiment of this invention;

FIG. 12B shows an overall shape of a floor of a blind, according to one embodiment of this invention;

FIG. 12C shows an overall shape of a floor of a blind where expansion rods are at a greater distance than a back wall, according to one embodiment of this invention;

FIG. 13A shows a front view of a 3-hub blind without expansion rods, according to one embodiment of this invention;

FIG. 13B shows an overall shape of a floor of a blind, according to one embodiment of this invention;

FIG. 14A shows a side view of a 3-hub blind with expansion rods in a deployed position, according to one embodiment of this invention;

FIG. 14B shows an overall shape of a floor of a blind, according to one embodiment of this invention;

FIG. 14C shows an overall shape of a floor of a blind, according to one embodiment of this invention;

FIG. 15A shows a side view of a 3-hub blind without expansion rods, according to one embodiment of this invention;

FIG. 15B shows an overall shape of a floor of a blind, according to one embodiment of this invention;

FIG. 16 shows a side view of a prior art 5-hub blind;

FIG. 17 shows a top view of a prior art 5-hub blind;

FIG. 18 shows a top view of a 3-hub blind without an innovative roof panel, according to one embodiment of this invention;

FIG. 19 shows a top view of a 3-hub blind with an innovative roof panel, according to one embodiment of this invention;

FIG. 20 shows a top view of a 3-hub roof panel, according to one embodiment of this invention;

FIG. 21 shows a top view of a 3-hub roof panel, according to one embodiment of this invention;

FIG. 22 shows a top view of a 3-hub roof panel, according to one embodiment of this invention;

FIG. 23 shows a skeleton front view of a 3-hub blind, according to one embodiment of this invention;

FIG. 24 shows an oblique perspective view of a 3-hub blind, as shown in FIG. 23;

FIG. 25 shows a perspective view of a symmetrical position or condition of support arms or rods, according to one embodiment of this invention; and

FIG. 26 shows a perspective view of an asymmetrical position or condition of support arms or rods, according to one embodiment of this invention.

### DETAILED DESCRIPTION OF INVENTION

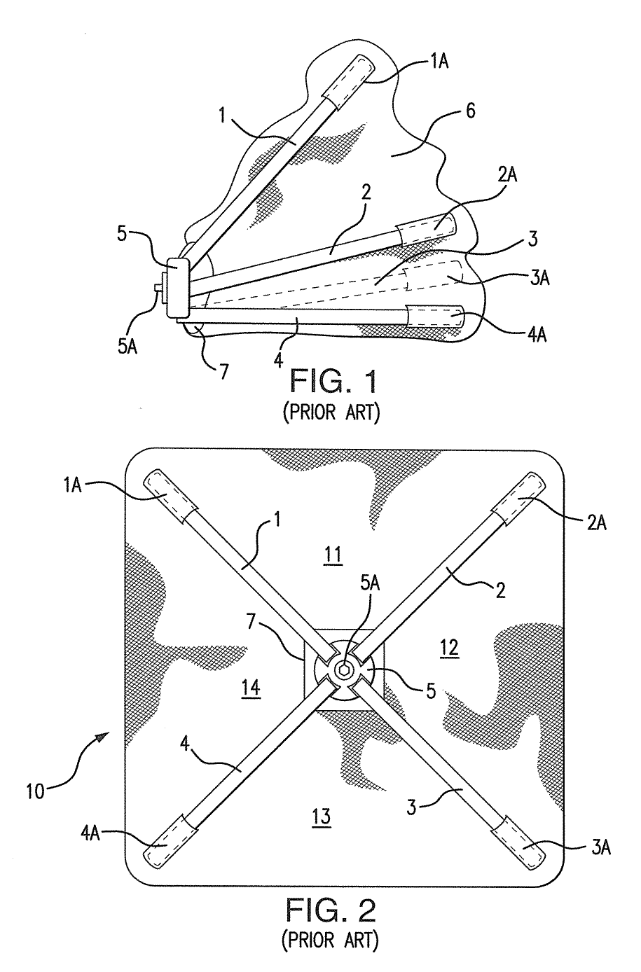

FIGS. 1-4 represent a basic prior art hub unit 10 with rods 1-4 attached to a central hub 5. This attachment to the central hub 5 allows the rods 1-4 to be securely attached without a chance or risk to be pulled from the hub 5 but also allows for the rods 1-4 to pivot, rotate and fold into a compact position. Fabric body 6 is made from a flexible material that can tolerate or stand up to the weather and maintain its strength. Fabric body 6 is attached to the hub by or using rod pockets 1A-4A. The rods 1-4 slide into the fabric rod pockets 1A-4A that are made from a durable sturdy fabric, known as webbing material, and sewn to the fabric body 6. The fabric body 6 is also attached to the central hub 5 by a bolt and nut 5A with a washer. The end of the bolt on the outside often has a loop hook with a fabric loop 25 sewn to it. This loop is pulled outward and deploys the hub into a taut position.

The center of the fabric body 6 where the bolt passes through is reinforced with heavy material which often has a heavy rubber texture 7, and this allows the fabric covering to maintain resiliency when the cover is adapting to the forceful deployment mechanism. A central hole or opening is put into the fabric where the bolt 5A passes through the hub 5 and through the hole in the fabric body 6 and the reinforced rubber texture fabric 7. This holds the fabric body 6 in the center in both the folded position and the deployed position. When the hub 5 is deployed, the fabric body 6 is pulled from the directional force of the 4 rod pockets 1A-4A equally and the center hole does not create tension in a single panel or quadrant 11-14 but keeps the fabric body balanced.

Windows are present in desired or opportunistic places along the panels 11-14 for viewing and shooting through and are not shown in the drawings. The body 6 floats freely, thus keeping the tension of the fabric body uniform. It is one object of this invention to provide or supply an external force outside the hub 5 to create a more concave top panel 11, as compared to a prior art blind through a concave triangular or triangle shaped roof panel. Prior art blinds do not have the physical abilities to sustain more concavity, thus more steep angled top panels in a single quadrant to resist or deter snow and rain. This is equivalent to increasing the slope or pitch of a roof to get snow to quickly fall off the roof.

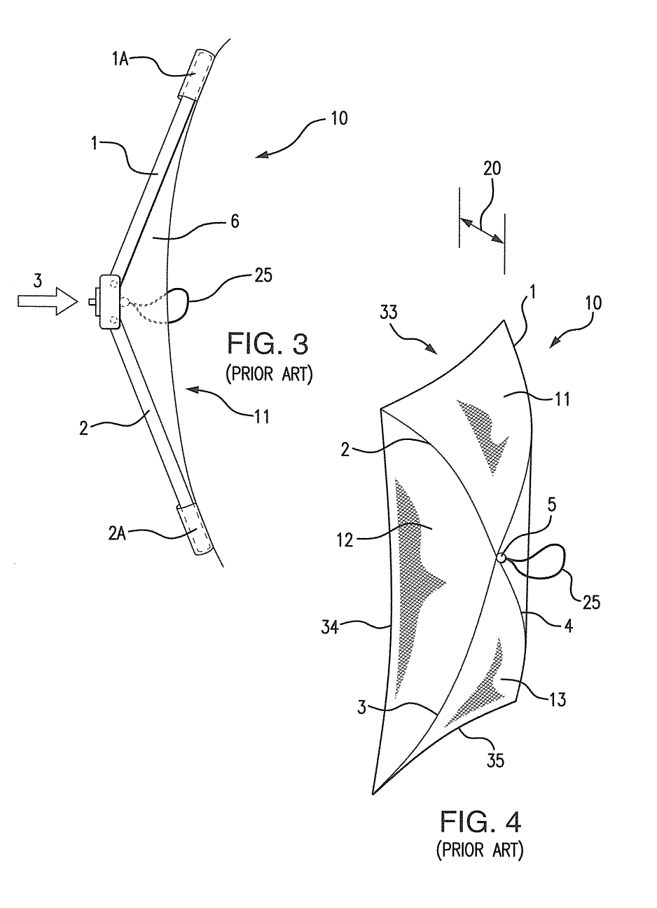

FIG. 3 shows a hub system 10 in a semi-flexed position before the hub pops inside out, in a convex position, and placing a palm of a hand on the hub 5 and pushing the hub 5 into the fabric body 6 allow rods 1-4 to evenly separate from one another. When the rods 1-4 separate and the central hub 5 is pushed into the fabric 6 the rods 1-4 are forcefully pushed against the rod pockets 1A-4A, and there is a point of this force when the rods 1-4 begin to contort in shape and the fabric begins to stretch. When the hub 5 is forced past or beyond this point, if all of the mechanics are correct, it will allow the hub 5 and the rods 1-4 to transition from being in a loaded concave shape to a loaded convex shape. The external fabric cover now creates outside-in forces against the internal frame system.

If the rods 1-4 are longer than allowed to flex they can tear through the rod pockets 1A-4A and render the blind useless. If the rods 1-4 are shorter than optimum or the rod pockets 1A-4A are stretched from normal use or fabric weakening this can produce a relatively weak hub that easily pops out of the convex position and renders the blind useless.

An alternative way of popping out the blind as described is to pull on the rope or webbing material 25 that attaches to the central hub hook bolt and the blind can set up from outside the overall structure. FIG. 4 demonstrates a fully deployed hub complex 10. Quadrants or panels 11-13 demonstrate the fabric body 6 separated into quadrants between the rods 1-4. The blind complex 10 has a limited ability to be convex as determined by the stretch of the fabric and the maximum distortion of the rods 1-4 when the hub transforms from concave to convex, as demonstrated by distance 20. Referring to FIG. 4, if the blind 10 was laid flat on the floor edges 33-35 as well as an opposing edge not shown, then it would rest on the floor. Hub 5 would be a distance of 10 inches in some applications. With measurement or distance 20, this distance is limited to the mechanism of the hub. It is one object of this invention to provide a greater depth of the hub complex and thus greater exterior convexity, allowing for longer life and a stronger structure of the blind.

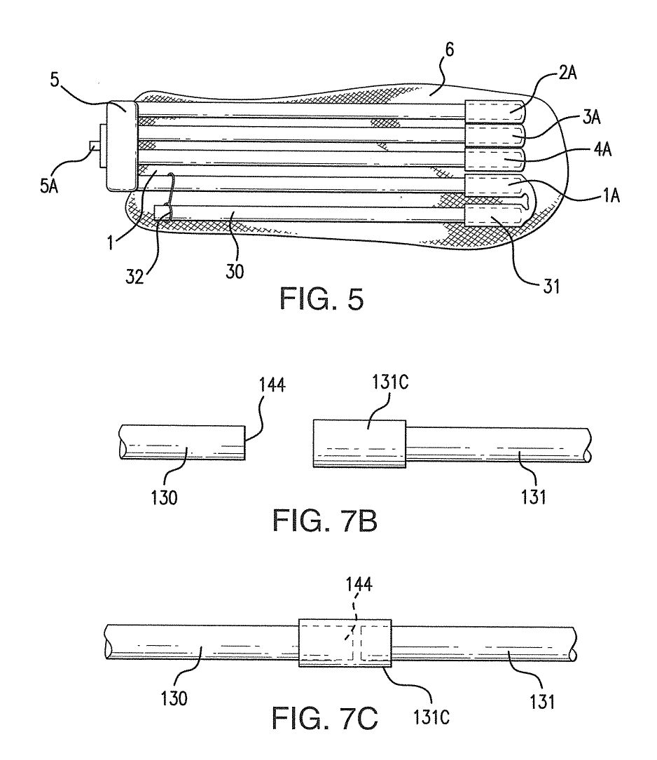

Referring to FIG. 5, the folded hub complex demonstrates the attachment of an accessory rod 30 at the adjoining rod pocket 31. The rod 30 is rigid and can be made from the same material as the hub complex rods and could optionally be constructed from other materials such as aluminum, steel, PVC plastic and/or any other suitable material and rod 30 could also have a telescopic mechanism for adjustable length. In some embodiments of this invention, rod 30 is the same size or shorter than the mating rod it borders. In a folded position, the rod pocket 31 hinges or acts like a hinge to bend or fold the rod pocket 31, and the accessory rod 30 selectively attaches via a hook or molded fastener 32 to the adjacent rod 1 for storage. In some embodiments of this invention, adjoining rod 1 has a fastener for accessory or expansion rod attachment.

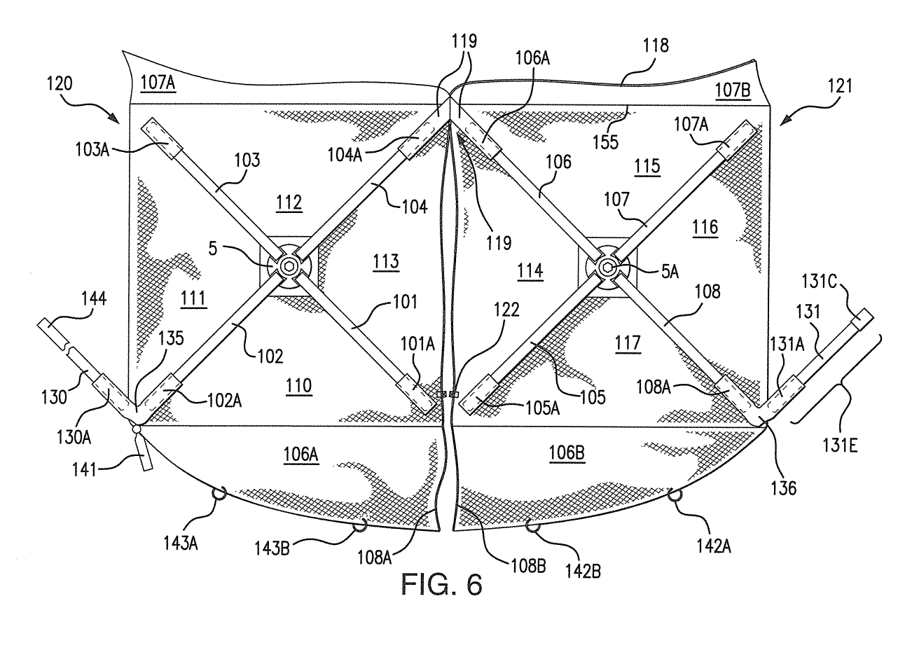

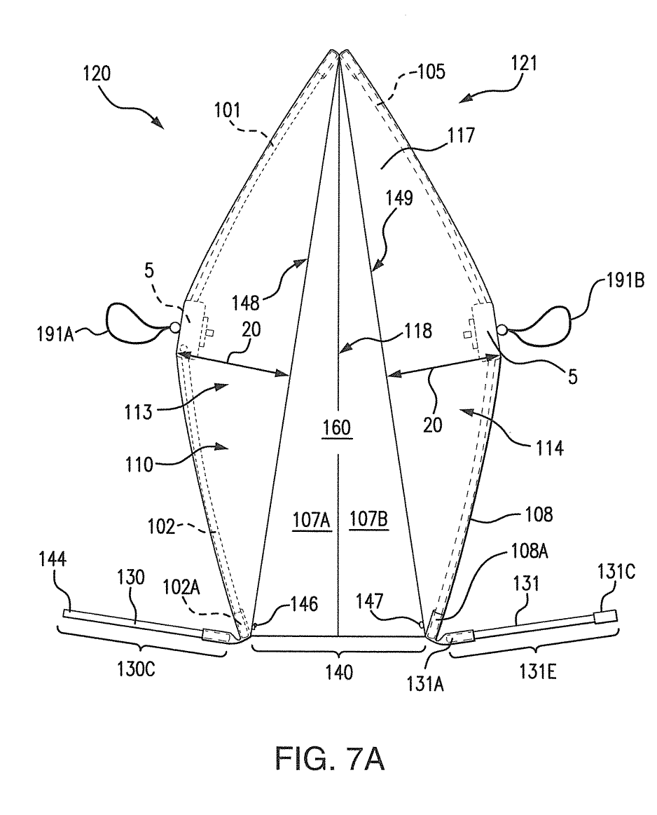

Referring to FIGS. 6, 7A, 7B and 7C, FIG. 6 shows a transparent top view of the 2-hub blind. FIG. 7A shows one embodiment of this invention without the front door panels, which is one object of this invention. Rear panels 107A and 107B are separated by central seam 118. In some embodiments of this invention, central seam 118 is a zipper for rear entry. Rear panels 107A and 107B can be constructed of a single piece of fabric. Front door panels 106A and 106B are preferably but not necessarily separated by a zipper 108A and 108B that starts at the corner of the joining rod pockets 119, where hubs 120 and 121 are secured, such as permanently attached. Throughout different embodiments of this invention, any suitable zipper, fastener, connector and/or other suitable attachment device or mechanism can be used at any suitable location or area to attach and/or connect 2 or more pieces or elements together, for example, to attach together or to each other 2 or more panels or other suitable elements.

In some embodiments of this invention, zipper 108A and 108B attaches quadrants or panels 113 and 114 and doorway panels 106A and 106B when the zipper is used. A snap fastener 122 is preferably but not necessarily attached at or near the rod pockets 101A and 105A and keeps the two panels connected and in close proximity or near each other and thus allows game viewing or other similar viewing through the top opening between panels 113 and 114 as well as between partially open door panels 106A and 106B, if desired. In some embodiments of this invention, separation rods 130 and 131 are attached by a mating rod pocket 130A to 102A and 108A to 131A. The mating rod pockets 135 and 136 allow for the swing arms 130 and 131 to bend and attach to their corresponding rods 102 and 108 via or with clips when the blind is folded for transport.

Referring to FIGS. 6 and 7A, hubs 120 and 121 lean together in an overall A-frame configuration. Rear panel 160 is illustrated or shown as being divided by central seam 118 between panels 107A and 107B and is sewn or otherwise attached or secured to hub complex 120 and 121 at the seam 154 and 155 respectively. Separation rods 130 and 131 are attached at the rod pockets 130A and 131A and are shown pointing to different directions as they fold or hinge freely. In some embodiments of this invention, separation rod 131 has a cylindrical receptor 131C which can accept the end 144 of rod 130 to adjoin rods 130 and 131. In some embodiments of this invention, receptor 131C is of or made of a tube, such as a tube made from plastic and/or any other suitable material, and of great enough diameter to accept the end of rod 144. In some embodiments according to this invention, the connection is a hinged connection.

Referring to FIGS. 7A, 7B and 7C, in some embodiments of this invention, if the user desires to implement the 2 accessory rods then the user would kneel down in front of the blind at the doorway. Taking hold of the right swing arm 131 with one hand and taking hold of left swing arm 130 with another hand, the user would align rods across the doorway in a hinged manner. The user would then push the rods apart so the rod end 144 of rod 130 would be placed inside the tube or receptor 131C. In some embodiments according to this invention, the mating rods constitute or form a bottom portion of an extra wall panel created by their connection or implementation. In some embodiments of this invention, the hubs 120 and 121 would twist, pivot and rotate to compensate for or respond to the force on the open corners of the hubs.

Referring to FIGS. 6, 7A, 7B and 7C, in some embodiments of this invention, when separation rods or expansion rods or expansion arms are used the effects of elastic deformation create internal forces stored in the contorted hubs allow them to return to their original shape and push the 2 rods 130 and 131 together inside tube or receptor 131C. Receptacle, tube or receptor 131C can be or have an angled shape, such as at any suitable angled shape, which allows for the separation rods 130 and 131 to create more or provide a larger or increased front door space by expanding outward past or beyond the blind frame, or can be straight for a straight line door entry arrangement. In some embodiments of this invention, rod 130 may be or is adhered, glued and/or otherwise attached in any suitable manner to receptor 131C or may be attached selectively in any other suitable manner.

Referring to FIG. 7A, in some embodiments of this invention, rear panel 160 is a smaller distance across at or near bottom 140 than a length of a swing arm length of rod 131 or 130. Measurement for distance 131E demonstrates the length compared to distance or width 140 which is the back panel length. Door panel 106A and 106B may be used both in a zipped position or with a single swing arm 130 or 131 and a single door panel.

Referring to FIG. 6, according to some embodiments of this invention, when cylindrical receptacle 131C is attached to a relatively small rod connector 141 at base of rod pocket 102A, a single door panel 106B can be used and swing arm 130 can be stowed away with door panel 106A against rod 102, as previously described. The use of rod 131, in some embodiments of this invention, creates or provides an extra wall and thus makes the blind larger than or compared to an arrangement without rod 131 but smaller than an arrangement using rod 130 simultaneously.

According to some embodiments of this invention, if the expansion rod length 131E exceeds a rear panel width 140 then the hubs 120 and 121 are forced to change or distort from their symmetrical position and energy will be stored to maintain a taut external cover. In some embodiments of this invention, rear panel 160 is pulled taut by the hub distortion as hubs 120 and 121 are separated forcefully in front by expansion rods and the rear panel is prevented from allowing the same resting distance or width 140. In some embodiments of this invention, when using a single front door panel, the opposite door panel is optionally stored by folding the opposite un-used expansion rod inward and attaching it to the mating rod. In some embodiments of this invention, using a single expansion rod 131 or both expansion rods 130 and 131 allows for an adjustable sized blind and an adjustable sized door, while being forced open without staking, according to some embodiments of this invention. For example, this arrangement allows for handicap accessibility, such as entry of a wheelchair.

Referring to FIG. 7A, in some embodiments of this invention, if accessory rods 130 and 131 are not used then hubs 120 and 121 can be joined by hook 146 and loop 147 or any other suitable fasteners and/or connectors. In some embodiments of this invention, the borders of hubs 120 and 121, 148 and 149 are the doorway in this 3-sided symmetrical application. To enter the doorway, for example, the user pulls apart these panels and steps through the doorway. This application would require staking the blind to maintain its structure like other conventional arrangements using gravity to maintain its resiliency.

Referring to FIG. 7A, in some embodiments of this invention, if rear panel 160 is removed then hubs 120 and 121 would freely move apart in a clamshell or pivot type motion when pulled from handles 191A and 191B. In some embodiments of this invention, when the blind complex 120 and 121 hinges freely between panels 113 and 114, rear panel width 140 prevents hubs 120 and 121 from separating a greater distance than a distance of the rear panel width 140. This is due to or because the structural integrity of hubs 120 and 121 maintain their preferred resting position. Separation rods 130 and 131 force the front and bottom rod pockets 102A and 108A apart which creates a loading internal force which pushes from inside out against the hubs, according to some embodiments of this invention. The hubs push inside out against the resiliency of the fabric cover and the rods push inside out against the hubs. The distorted hubs then pull outside in or on rear panel 160 allowing it to forcefully maintain the structure without a collapse and without a structural support across its periphery.

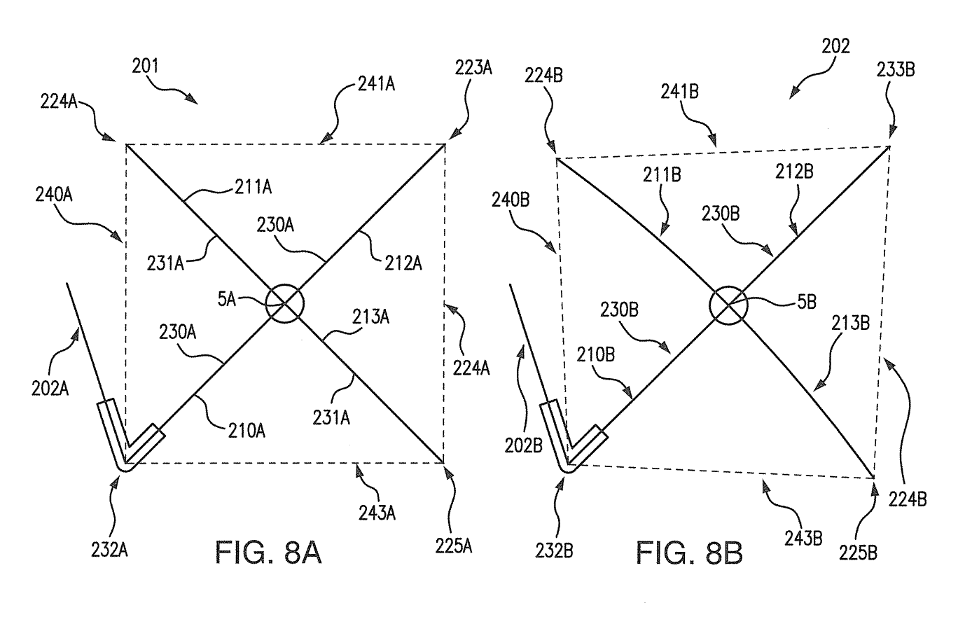

FIGS. 8A and 8B show a side view of a right hub of a 2-hub or 3-hub blind when the loading mechanism is as shown in FIG. 8B and is not as shown in FIG. 8A implemented by use of rods 202A and 202B. FIG. 8A shows or demonstrates minimal or no contortion of rods and a symmetrical shape, where FIG. 8B shows or demonstrates an arrangement with contortion. The 2 planes are shown or represented by a combination of rods 210 and 212 representing or forming one plane 230 and rods 211 and 213 representing or forming another plane 231. Planes 230A and 231A show or demonstrate a symmetrical shape as expansion rod 202A is at rest or in a rest position. Rod plane 230B and 231B are asymmetrical or approximately asymmetrical as rod 202B is used and causes contortion. In some embodiments of this invention, the physical characteristics of asymmetry are created by the implementation of or using separation rod 202B. As the user forces rod 202B acting on the free corner rod 210B which is bordered by 2 free edge panels 240B and 243B at the bottom of the hub, in a cross motion, rod 211A and 211B are held stationary to the opposite hub at point 224.

In some embodiments of this invention, corners of the hubs are referred to as being where the rod ends. Referring to FIG. 8B, the free or open corner 232B is the only corner not held stationary when expansion rod 202B acts on the free corner 232B and the mirror image left panel is not shown. The rod corners 224B, 223B and 225B have an attachment to structures that hold them stationary while rod 202B acts on the free corner and the effects transfer to the entire structure.

In some embodiments of this invention, rod 213B is held stationary by its rear panel attachment, for example, because accessory rod 202B is longer than the rear panel width at the bottom. As the junction of rods 202B and 210B at adjoining corner or rod pockets 232B are forced outward, rods 210B and 212B of rod plane 230B maintain a more straight line appearance closer to their original shape without distortion and rods 211B and 213B of plane 231B flex into an arc that creates much more convexity than a hub mechanism can generate by itself or on its own. In some embodiments of this invention, a single plane created by rods 211B and 213B are designated or numbered plane 231B which is arced into a hyper-flexed convex position creating a relatively more concave internal structure. This arrangement creates a stronger asymmetrical structure with an extra wall and greater floor space.

In some embodiments of this invention, to implement expansion rods to act on the open corners 232A and 232B, of a blind structure at the inferior rod pockets at the floor and doorway results in separation of the bordering hubs, transforming the hubs from a general symmetrical to a general asymmetrical shape and convex to more convex throughout the entire structure.

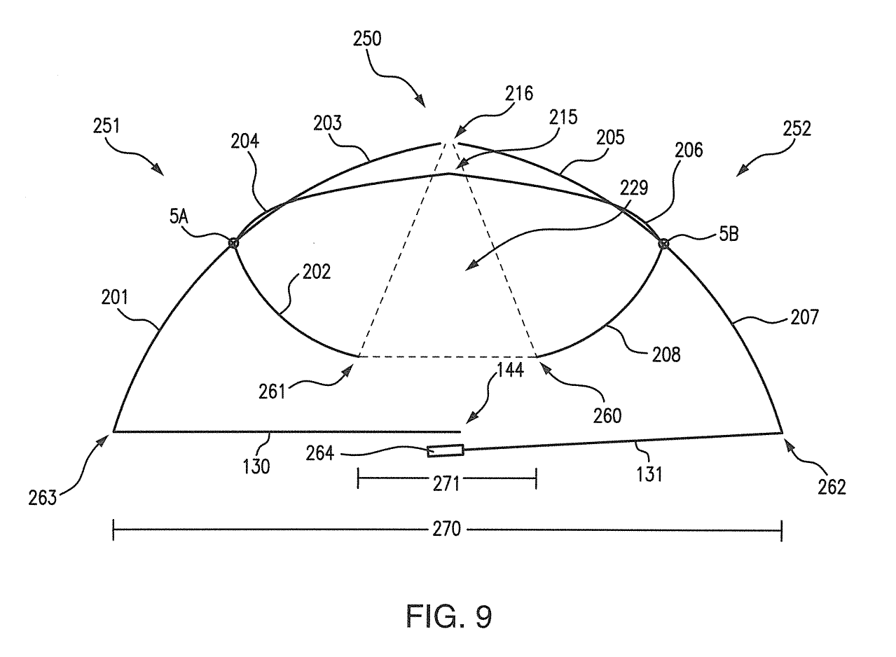

Refening to FIG. 9, the 2-hub skeleton view blind 250 is represented by 2 hub complexes 251 and 252. Each of the hubs have 4 rods attached to a central hub 5A and 5B. Rod pockets not shown in the drawings are used to attach rods 203 and 205 at or near point 216. Rod pockets or an optional snap hook, if an optional zipper is used, secure rods 204 and 206 together at point 215. In the case or embodiment of no zipper, an adjoining rod pocket would permanently position rods 204 and 206 to point 215. Points or locations 260, 261, 262 and 263 are secured or otherwise attached to the fabric body with or via rod pockets which are not shown in the drawings. When expansion rods 130 and 131 are connected by inserting the rod into connector 264 the force of the distorted hubs 251 and 252 keep them together with constant pressure. Rods 130 and 131 optionally may connect to one another by or via a hinge connection that may be selectively removed or permanently attached.

In some embodiments of this invention, when 2 hubs 251 and 252 are deployed into their loaded convex external position, the blind assumes a resting shape similar to that shown in FIG. 7A in that or because points 260 and 261 represent the relaxed back panel and points 263 and 262 mirror image this position in front without expansion rods 130 and 131 used. Any attempt to separate hubs 251 and 252 past or beyond distance 271 would result in distortion of the shape of the deployed hubs.

In some embodiments of this invention, with implementation of the expansion rods, as rod 131 pushes rod 207 laterally, and rod 130 simultaneously forces rod 201 laterally, the separation of corners 263 and 262 opens the front doorway past or beyond its resting distance as measured at 271 which is the distance across back panel 229 at the bottom or floor. After rods 130 and 131 are secured or otherwise attached by or via a connector, in some embodiments of this invention, they rest on the ground and form the bottom of the doorway. As rods 130 and 131 force the 2 hubs 251 and 252 apart, rods 201 and 203 on hub 251 assume a less convex position and more straight line, while the 2 rods in the opposite plane 204 and 202 assume more or a greater convexity. In this specification and in the claims, this is defined as asymmetry and hyper-convexity and generates greater internal force.

The loading mechanism of the rods 130 and 131 create asymmetry between the 2 axes lines or planes represented by straight line rods 201 and 203 and arched rods in the second plane, rods 202 and 204. Hub 252, rods 205 and 207 transform to a more straight or less convex position while rods 206 and 208 that are in the opposite plane transform to a more convex position. As rods 130 and 131 force or cause separation of corners 263 and 262, rods 208 and 202, as shown in FIG. 9, try to separate to avoid contortion, and rear panel is pulled tight. In some embodiments of this invention, rear panel 229 has a smaller cross distance 271 than doorway opening 270 and stores the energy of the contorted hubs 251 and 252. This type of structure can, for example, roll in an end over end manner and still maintain its inside out force and stored energy or other dynamic energy.

In some embodiments according to this invention, internal, or inside out, forces are generated with swing arm expansion rods at the doorway also while anchoring the rear rods 202 and 208 to a dimension shorter than the front opening. This arrangement creates a 4-sided structure that maintains internal pressure through 2 hub units and 2 door panels by generating force from a single side, such as the front. A rear panel can be removed and points 260 and 261 permanently attached and a three-sided loaded structure can be an alternative embodiment of this invention.

In some embodiments of this invention, such as shown in FIG. 9, rods 130 and 131 are used separate or together as long as there is separation of points 263 and 262 greater than a distance of back panel bottom 271 which represents a distance between points 261 and 260. The distortion of hubs 251 and 253 past or beyond their physical resting tension created by their deployment, generate a loaded internal force as the rods resist or fight to maintain their resting position.

According to some embodiments of this invention, an internal force pushes out against the entire structure including the rear panel 229 and front door panel or panels. Tightness in the external flexible cover can be used to prevent fabric flap in the wind which scares game and furthermore allows the blind to stay self-erected without using stakes at the bottom corners to prevent collapse.

Conventional tents use supports outside the structure of their frame systems. The fabric maintains tightness by pulling fabric from the top out and not the outside in as demonstrated in this invention. The force created by rods 130 and 131 is internal pushing out because hubs 251 and 252 are hyper-flexed, past or beyond their flexed or deployed resting position. Furthermore, unlike this invention, the prior art method of using rods or support arms to position hubs to form a box type structure does not create “stored energy” to create tension in the fabric body beyond the structure for which it is designed.

The prior art portable structures using tubes or rods to support side walls and roof structures in a box type manner lack the ability to adapt to multiple size blind applications such as adding or removing a wall, as described in this specification, and changing the size of a doorway with using a single or both expansion rods, because the tension of the external fabric is limited to the exact size of the support. Furthermore, hubs lack the ability to prevent buckling or folding in the corners without brackets.

According to some embodiments of this invention, the adaptable size described with using a single or both expansion rods 130 and 131 while tension is maintained or remains should be realized, such as in the case of handicap accessibility. The expanded doorway allows for the entrance of a wheelchair where the smaller doorway using a single rod may be more favorable or opportunistic when the user requires more front height and less floor space. Floor space, door size, convexity, number of external walls and blind panel tensions are all adjustable with the described system according to this invention.

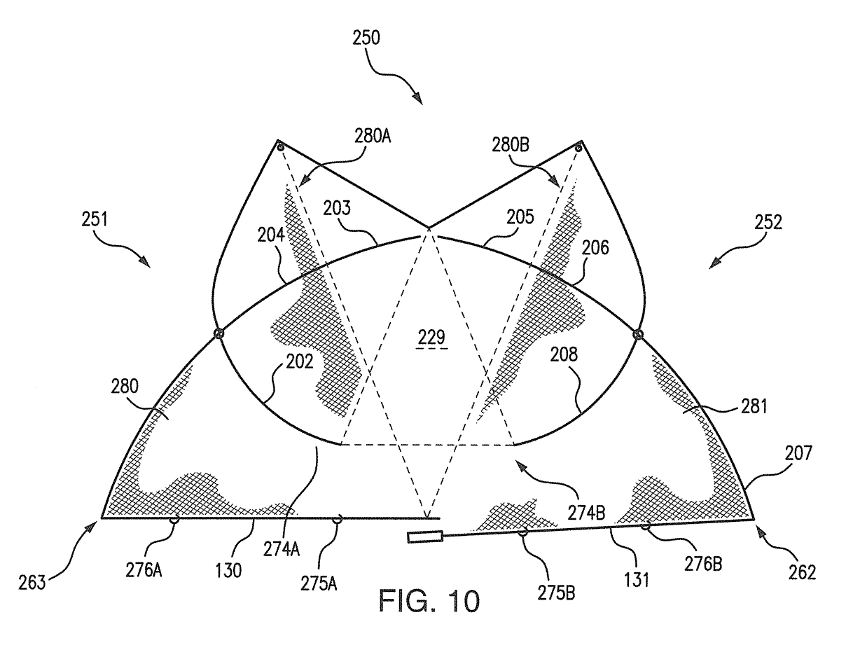

According to some embodiments of this invention, as shown in FIGS. 9 and 10, the described term the “stored energy” or loaded system is demonstrated in or by the blinds ability to pop open under force as described in the following. The transition in shape with using rods 130 and 131 is contortion and asymmetry with a lowering of the front height at point 215 and a maintaining of the rear height at points 216, according to some embodiments of this invention. Referring to locations or points 263 and 262 as they are spread open to a center height at 215 is dropped down making the front of the blind lower with expansion and higher without expansion.

Referring to the rear panel 229 as shown in FIGS. 9 and 10, the rear panel 229 maintains its structure regardless of the external forces where the entire perimeter is not acted on by a frame system. In some embodiments of this invention, wind or the weight of the blind rolling end over end allows for the distance 271 to be maintained regardless of the lack of a support rod across this structure. This force is generated by points 261 and 260 being forcefully pulled by the arcing rods 202 and 208. This pulling force against the periphery of the back panel creates or provides tightness regardless of having a support bar across the bottom of panel 229. This is not the case with any other mechanism and is one object of this invention. This eliminates the need to stake the blind of this invention, for example, to avoid collapse in the wind.

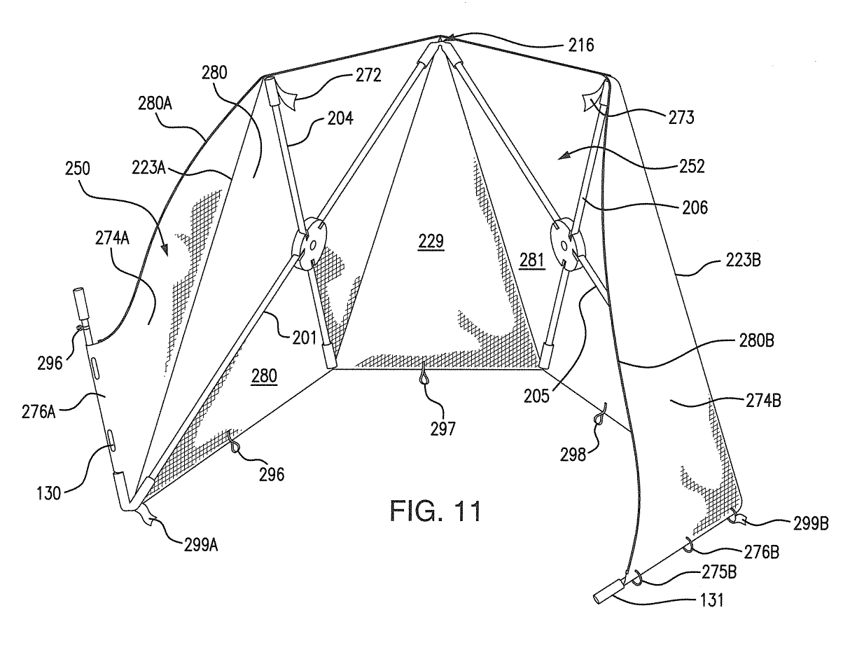

Referring to FIGS. 10 and 11, according to some embodiments of this invention, the front view of the 2-hub blind 250 shows the left hub 251 and right hub 252 when the door panels 274A on left and 274B on right are used to create or provide a 5 walled open force loaded structure. As the front snap clips 272 and 273 are unlocked the loaded hubs are free to separate and respond by uncoiling and the hyper convex rods 204 and 206 and their mating inferior rods in the same plane 202 and 208 immediately and forcefully spring to the straighter line position or symmetrical position, consistent with the pre-distorted deployed hub shape.

In some embodiments according to this invention, the door panel has a central zipper 280A and 280B at the center of door panels 274A and 274B. The attachment of door panels at points 275A and 276A on the left and 275B and 276B on the right prevent rods 272 and 273 from fully extending to the “unloaded” symmetrical position as the zipper remains taught and is held down from being relaxed by clips 275A and 275B and thus the entire structure with 5 panels remains intact and taut. In some embodiments of this invention, rods 204 and 206 do not lose their entire amount of stored energy and continue to load the entire structure. If hooks 275A and 275B are not intact, rod 204 and 206 would be allowed to frilly flex into its semi-relaxed position, such as when the hubs are deployed and not contorted.

In some embodiments of this invention, the push button implementation of opening the roof in a spring loaded fashion is a useful application for hunting overhead and maintaining concealment until the last moment or minute. The 5 taut panels, “open top” enclosure is represented by the rear panel 229, side panel 280, front left door panel 274A, front right door panel 274B and right side hub panel 281. In some embodiments of this invention, it is intended to fully separate the rods 130 and 131 and open the entire structure into a 5-sided or 5-panel game shield. The attachments of the front door panel at 276A and 276B and 275A and 275B can be accomplished with or via a sleeve or multiple fabric sleeves or with hooks and/or a hook and loop attachment, as well as any other suitable connectors, fasteners and/or hooks.

In some embodiments of this invention, when rods 130 and 131 are folded in transport position panels 274A and 274B are folded in a position that prevents bunching of fabrics. Rods 130 and 131 can be permanently attached with or via a hinge connection as well as can be separate. They can optionally be selectively removed for transport. Referring to FIGS. 10 and 11, central zipper 280A and 280B can be partially zipped to create more tension on door panels 274A and 274B thus regulating the amount of tension generated between the 5 identified walls or panels in the semi-open configuration shown or illustrated in FIG. 10.

According to some embodiments of this invention, the 2-hub blind can be used as a prior art 3 walled symmetrical blind comprising hub 251, back wall 229 and side hub 252, without the implementation of the rods and requiring staking to maintain stability. In some embodiments of this invention, it is then used as a 4-sided asymmetrical blind with a single rod 131 used and rod 130 and door panel 274A in a transport position storage. In some embodiments of this invention, it is used in a 4-sided larger door with both expansion rods used. Additionally, the 2-hub blind is used as an enclosed 4-walled pop open blind with the top open. Additionally, it is used as a game shield with the back open and spread apart thus the name of a “hybrid”, multi-use, multi-sized blind. In some embodiments of this invention, a front door panel may be absent or may be removed. According to some embodiments of this invention, it is possible to increase size and change shapes based on hunting applications. Further, referring to FIGS. 9, 10 and 11, back wall 229 may be eliminated.

FIG. 11 numbers the 5 wall panels 274A, 280, 229, 281 and 274B. In some embodiments of this invention, panel 274A is in a slightly folded position with the fastener 296 removeable and attaches to an adjacent or a nearby rod 201 in a transport position. In some embodiments of this invention, swing arm 131 is in a slightly deployed position allowing a hunter to hide between hub 252 and door panel 274B. Fabric loops or other suitable connectors allow for staking the open game shield to the ground along a bottom periphery as shown by locations 296, 297 and 298. In some embodiments of this invention, sleeves are present for attachment to door panels to separation rods 275A and 276A. Expansion or separation swing arms 130 and 131 are stored or stow away with attachment to adjacent or nearby rods 201 and 205 and door panels 274A and 274B are stowed away for use as a 3-sided blind.

According to some embodiments of this invention, the door panels, thus a single wall, uses the 2-hub blind as a 3-side symmetrical blind with rods in a transport position. Snap hooks 299A and 299B hold opposite hubs 251 and 252 together in a closed position and snap hooks 272 and 273 hold the top portion together, while the doorway is made at their junction at walls 223A and 223B.

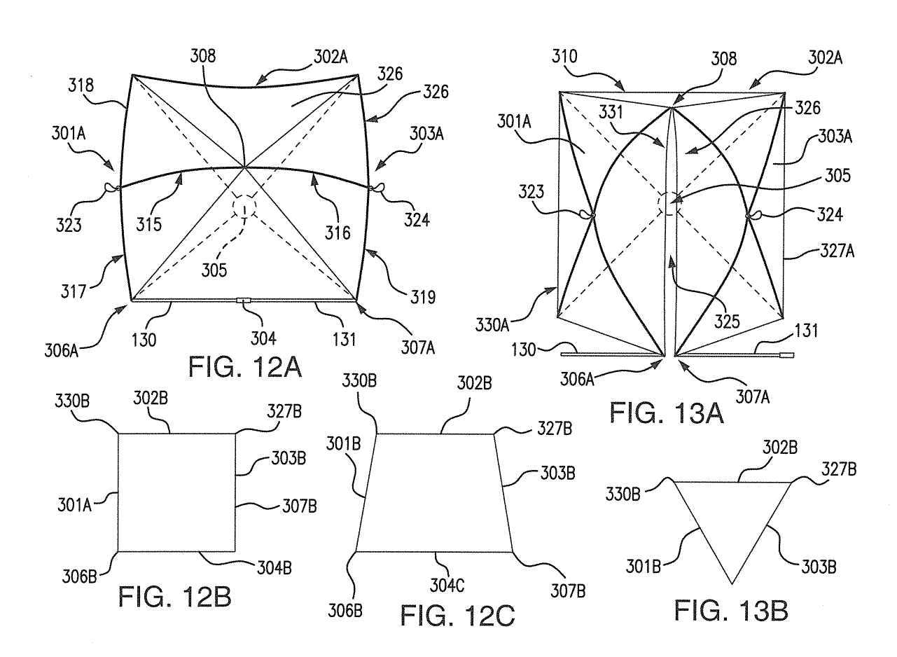

Referring to FIGS. 12A, 128, 12C, 13A and 13B, according to some embodiments of this invention, the 3-hub blind has hubs 301A, 302A and 303A joined and/or otherwise connected to form 3 sidewalls. Two of the borders are permanently attached at a seam 330A and 327A where the fabric bodies are sewn or otherwise attached or connected together. FIGS. 12B, 12C, 13B, 14B, 14C and 15B each is a top view of the floor shape of the corresponding blinds illustrated above, and show or demonstrate the attachment of hubs vertically at seams 330B and 327B where hubs 301A and 303A show or demonstrate only a selective attachment to allow opening 325 for a doorway. In some embodiments of this invention, sidewall 304B and 304C are provided or created by door panels and the other 3 sides are provided or created by hubs. In some embodiments of this invention, the door panel can be removed and the bottom of the entry would be the position of the expansion rods. In some embodiments according to this invention, doorway opening 325 on FIG. 13A is accessed by separating hubs 301A and 303A by pulling panel border 331 and 326 apart and stepping into the blind. If corners 306A and 307B are attached with or via a snap fastener the hubs flex and allow the user entry or to enter. If no snap fastener is used, point 306A and 307B separate and allow the user entry or to enter. In some embodiments of this invention, doorway opening 325 springs back into its resting position if not forced open with rods 130 or 131 or both rods used together. When the 3-hub blind is used without rods 130 and 131, doorway opening 325 is in a closed position. When the 3-hub blind is used without rods 130 and 131 they are attached to their adjacent rods as described in the 2-hub embodiments of this invention and the front door panel 321 is attached to the bordering panels with fasteners, such as flexible cords, snaps, zippers and/or any other suitable connection device or fastener.

In some embodiments of this invention, the physical transformation from a 3-hub, 3-walled symmetrical structure to a 3-hub, 4-walled asymmetrical structure is based on hunting applications, weather conditions and also floor space requirements. When users desire an upright and symmetrical shape of their hunting structure which is beneficial for gun hunting they will use the 3-hub, 3-sidewall arrangement or configuration, which in some embodiments of this invention is taller and more beneficial in a standing position of the user. In some embodiments of this invention, the roof is taller throughout the center or central area, where the hunter would stand. This roof alignment would likely not resist or deter snow accumulation.

In some embodiments according to this invention, when the user desires a stronger and larger structure with the possible addition of more people to fit inside the tent, it will require greater floor space, and the rods 130 and 131 would be used or implemented to form a fourth wall 303B and 304C. In some embodiments according to this invention, wall 304C is at a greater distance across than or as compared to wall 304B. In some embodiments according to this invention, the combination of rods 130 and 131 have a greater combined length than or compared to back wall 302B. In some embodiments of this invention, rod 130 and/or rod 131 each is telescopic and/or adjustable in length.

Although prior art hub style blinds that maintain or have enough strength to stay open without using stakes require building a box structure including 4 sidewalls and a top roof panel, and the sidewalls are required to be the same size as the adjoining hubs or else the pieces of the box would not fit. In some embodiments according to this invention, it is possible to provide a front door opening 304C of greater width than opposing rear hub, opposite the doorway, for example, for handicap accessibility. When increasing the size of the doorway, for example, it can be up to 100% wider than opposing panel. All of the disclosure describing the 2-hub embodiments of this invention apply to the 3-hub embodiments of this invention, particularly as it pertains to door size and the physical changes of the two opposing hubs 301A and 303A.

According to some embodiments of this invention, such as shown in FIGS. 12A and 13A, points 306A and 307A are or form the unattached or free corner of the hubs. In some embodiments of this invention, the free corners are the only portion of the blind where the bottom portion of the structure can be separated for entry, and this, for example, is where the separation rods 130 and 131 attach with or via mating rod pockets. In some embodiments of this invention, the roof panel 326 has no structural support rods or hubs and functions to act on top bordering panels. In some embodiments of this invention, door opening 325, side seams 330A and 327A are vertical when rods 130 and 131 are not used or implemented.

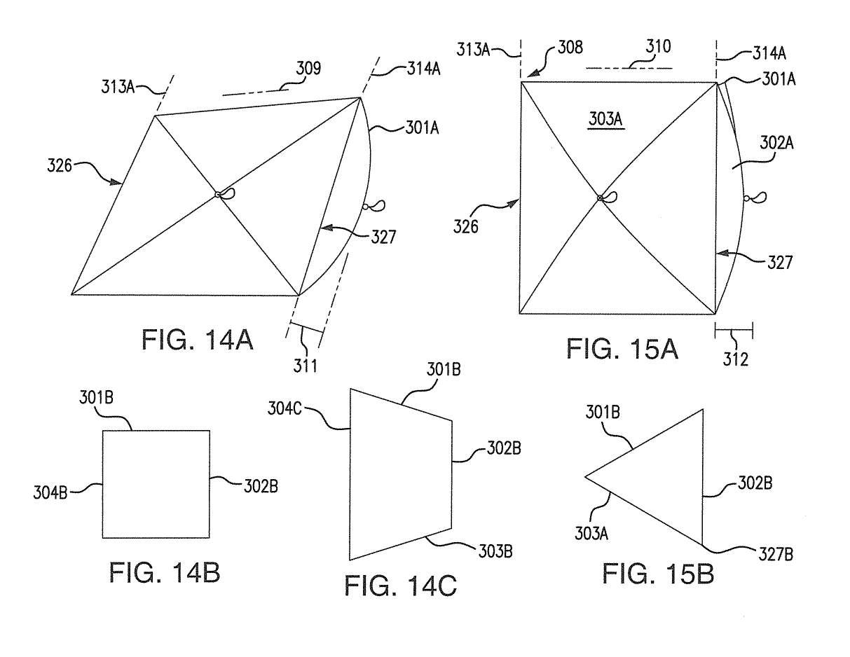

According to some embodiments of this invention, when rods 130 and 131 are used the 3-hub blind transforms to a 4-sided blind and this results in a transformation of all three hubs that is explained in great detail. 3-hub blind front and side perspective views without rods 130 and 131 used show the vertical position of hub 303A at doorway opening 325 and panel border 326 as well as seam 327A and 330A. Point 308 drops down in position when rods 130 and 131 are used or implemented, thus lowering the height and increasing the roof angle 309. According to some embodiments of this invention, FIGS. 14A and 15A show the corresponding floor space perspectives as a single expansion rod is used or implemented on free corners 306A or 307A and a sidewall 304B is created or provided. When both rods are used, the front wall or doorway is larger, for example about twice larger, than sidewall 304C. In some embodiments of this invention, the hub 303A and 302A has an upright position without the implementation of rods 130 and 131 as indicated by lines 313 and 314. In some embodiments of this invention, the roof line is level or generally level, as indicated by angle 310. In some embodiments of this invention, with implementation of expansion rods, the forward edge 326 slopes forward toward hub 302. If a plumb bob was dropped from point 308 it would be ahead of or in front of the door threshold formed by rods 130 and 131. This allows a user to enter a ground blind with the top of the blind not obstructing the user's head. In some embodiments of this invention, the user can step over the rods or threshold and not be obstructed by the top 308 of the blind which is one object of this invention. This can be, for example, several feet in front of point 308 if extension rods or expansion arms are used, thus increasing the blind space outside the hubs. In some embodiments of this invention, angles 313A and 314A slope forward toward hub 302. In some embodiments of this invention, hub 302 has, assumes and creates a convexity and greater strength as measured at measurement or distance 311. Measurement or distance 312 often lacks convexity past or beyond the physical limitations of the 4-hubs. In some embodiments of this invention, the transformation from a 3-sided 3-hub symmetrical structure to a 4-sided 3-hub asymmetrical structure provides physical stability by acting on a single side and causes increased convexity of all three hubs. In some embodiments of this invention, doorway panel 321 has three sides and three angles with a preferred central zipper but may be also on the side or circular. In some embodiments of this invention, the bottom threshold is formed by rods 130 and or 131 and the doorway slopes forward, away from the floor when rods are implemented.

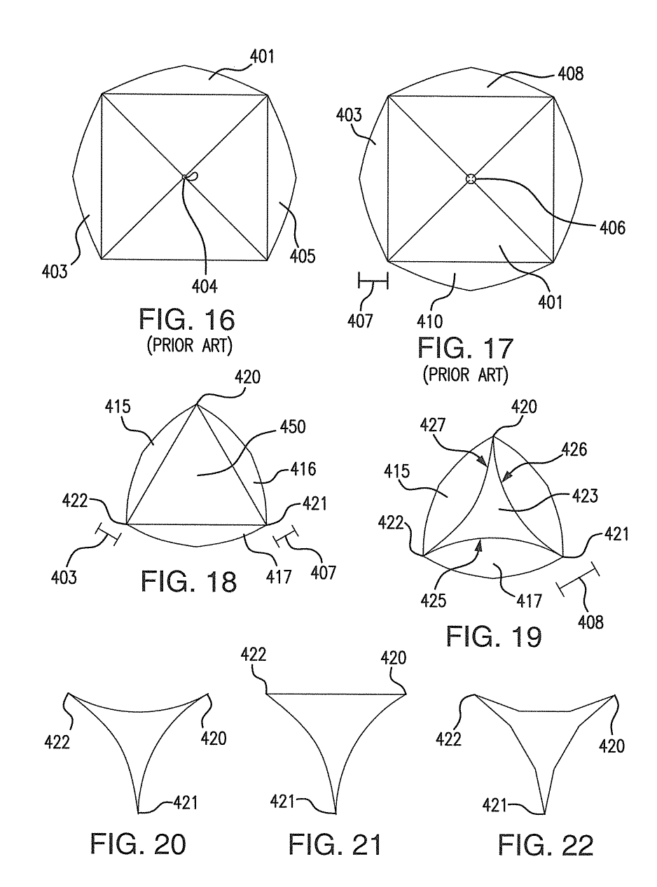

As shown in FIG. 16, the roof hub 401 is in a front view and 401 is in a top view of a 5-hub blind and is made from a structural hub shown hidden or transparently at 406. In some embodiments of this invention, when snow accumulates on the roof, the hub collapses and is trapped inside sidewalls 40313, 408B, 40913 and 410B which can cause a 5-hub prior art blind to break rods as the snow overpowers the overall structure. In some embodiments of this invention, the hubs have a maximum amount of convexity and they are limited to with the mechanism as shown by measurement or distance 407. In some embodiments of this invention, it is not possible to change the tension or convexity of a single hub and thus a single quadrant or panel in a 5-hub structure because the pieces need to fit integrated or like a puzzle.

According to some embodiments of this invention, such as shown in FIGS. 18, 19, 20, 21 and 22, the innovative triangle roof line of this invention, with exponentially less fabric or a concave shape, used at one of the three corners provides more slope at the top panels of the bordering sidewalls and thus allowing for a greater angled roof to prevent snow accumulation and to eliminate the top roof hub while continuing to support the overall or entire structure. FIG. 18 is a top view of a 3-hub blind showing a triangle shaped roof panel 450 without the innovative design. Corners 421, 422 and 433 where top rods of adjoining sidewall meet, is where the roof panel starts and it continues along the border of each of the three top panels of the 3 sidewall hubs 425, 426 and 427. In some embodiments of this invention, the roof panel is made of a flexible resilient fabric which is sewn to the fabric body of the 3 joining side panels. Measurement or distance 407 can be the same as a measurement of any prior art hub blind because the convexity of the hub is limited by the huh characteristics as well as the limitations of having to mate to the adjacent hubs to form a boxed structure as previously described.

FIG. 19 shows that the top panel 423 assumes a shape that allows for the triangle to arc inward at points 424, 425 and 426. The roof panels assume a triangle shape with concavity at 1 or more of the 3 sides. This inward arc further loads and pulls the top panels of the bordering sidewalls into tension of greater capability to the limited hub mechanism. Measurement or distance 408 shows or demonstrates more convexity and thus more strength in the three sidewall hubs by the method of using a fabric roof panel of this invention that provides increased tension on the bordering top panel. FIGS. 20, 21 and 22 represent roof panel shapes that create more convexity in their bordering 3 hubs.

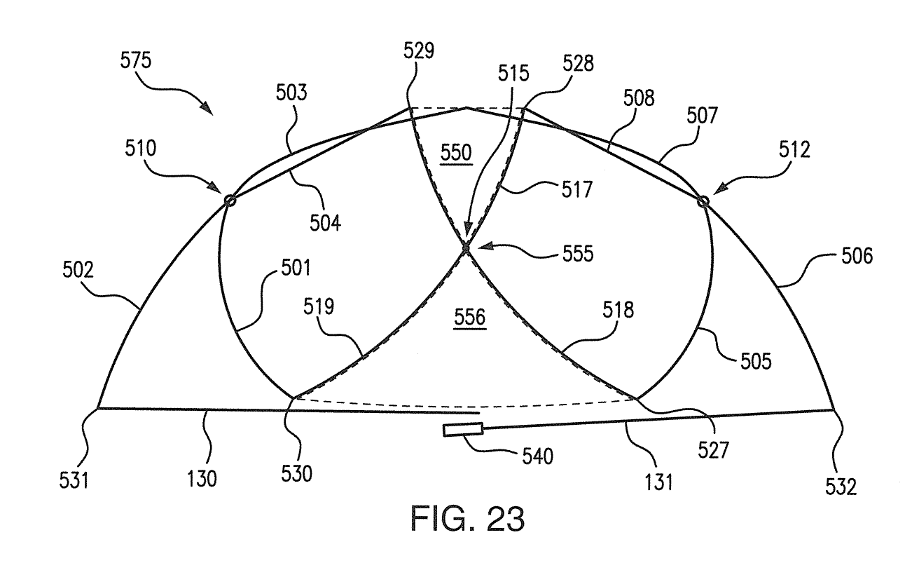

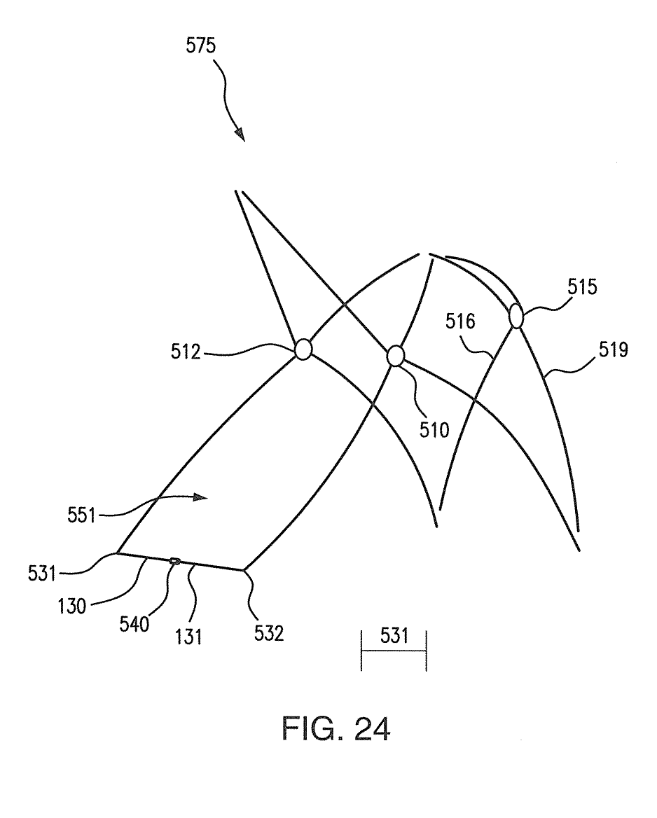

According to some embodiments of this invention, FIGS. 23 and 24 show the 3-hub blind skeleton that represents the same structural construction or make-up of the 2-hub blind shown in FIGS. 9 and 10, and the physical attributes of the 2 hubs 510 and 512, with expansion rods 130 and 131 remaining the same. In some embodiments of this invention, the physical differences are exclusively to the third hub 515, which is opposite of the doorway opening 551. In some embodiments of this invention, the doorway is formed at the base of the expansion rods 130 and 131 and the door panels connect and operate the same as described previously in the 2-hub embodiments or applications of this invention.

In some embodiments of this invention, such as showing FIGS. 23 and 24, rods 504 and 508 are desired to maintain a more or relatively straight line position in relation to lines 503 and 507 which are forced into a convex or arced position. In some embodiments of this invention, the flat position serves to push against the top rear hub panel 550, as indicated by the dashed lines, of central hub 515 and provide or create a caving in and more concave top panel. In some embodiments of this invention, this forces the center hub 555 into a much more convex position than it can achieve by the hub mechanism capabilities as measured by distance 531. The bottom panel 556, formed between roods 518 and 519 assumes a flat position, such as hyper-flexed rods 501 and 505 acting with a pulling motion. In some embodiments of this invention, the end result is a convex hub 515 of greater distance at 531 to accommodate a more ball shaped and less flat walled structure. In some embodiments of this invention, the appearance of hub 515 is that of or corresponds to a bow shape, which is the shape of some archery gear or equipment used by a hunter. The asymmetrical leaning forward toward hub 515 demonstrated in FIG. 24 shows that the increased space and convexity in the front portion of the blind, according to some embodiments of this invention, opposite the doorway are or form larger windows and thus shooting capabilities are most advantageous opportunistic.

According to some embodiments of this invention, when the 3-hub blind 575 has no implementation of or use of expansion rods, it assumes an erect and symmetrical 3-sided blind with all sidewalls having integrity and hubs being in their relaxed and deployed shape. Accessory expansion rods and front door panels function the same and have the same option available with 2-hub or 3-hub embodiments according to this invention.

It is then realized that expansion rods acting on the bottom free corners of a hub enclosure causes a reversible elastic deformation of the blind structure generating sustained stored energy, increases the strength, allows for adjustable space and creates an additional sidewall. This physical premise is described as Hooke's Law.

According to some embodiments of this invention, a blind structure comprises a first panel, a second panel, a first hub structure having a first hub and at least one support arm or rod positioned next to or near the first panel, and a second hub structure having a second hub and at least one support arm or rod positioned next to or near the second panel. In some embodiments of this invention, the first hub structure is connected, secured and/or otherwise attached directly or indirectly to the second hub structure. In some embodiments of this invention, an expansion arm or rod is connected, secured and/or otherwise attached directly or indirectly to the first panel and/or the second panel.

According to some embodiments of this invention, a method for constructing a blind structure comprises or includes forming a first hub structure with a first hub and at least one first support arm or rod contacting a first panel, and also forming a second hub structure with a second hub and at least one second support arm or rod contacting a second panel. In some embodiments of this invention, the first hub structure is connected with the second hub structure, for example, with any suitable connector, fastener, attachment and/or any other suitable connection device. In some embodiments of this invention, an expansion arm or rod attaches, secures and/or otherwise attaches the first panel directly to and/or indirectly to the second panel.

According to some embodiments of this invention, the expansion arm has an adjustable length and the expansion arm can be adjusted in length and then secured or locked into place or position, such as between the first panel and the second panel to form a fixed distance between the first panel and the second panel. In some embodiments of this invention, the expansion arm is a telescopic arm or can otherwise be adjusted in length and then locked into a fixed or secured position.

In some embodiments of this invention, positioning, inserting, attaching, securing and/or otherwise fixing the position of the expansion arm with respect to the first panel and/or the second panel causes or results in the first hub being forced towards and contacting the first panel and/or results in the second hub being forced towards and contacting the second panel. In some embodiments of this invention, positioning the expansion arm in a fixed position with respect to the first panel and the second panel causes at least one support arm or rod to transition or transform from a symmetrical condition or position to an asymmetrical condition or position. In some embodiments of this invention, when the expansion arm is not in a loaded position or condition, the support arm or rod is in the symmetrical condition or position, and when the expansion arm is in a loaded position or condition, the support arm or rod is in the asymmetrical condition or position.

As used throughout this specification and in the claims, the term “symmetrical” is intended to relate to a no-load or an unloaded condition or position of the expansion arm in which the expansion arm is not connected to the first panel and the second panel and thus does not force-load the hubs, and the term “asymmetrical” is intended to relate to a with-load or loaded condition or position of the expansion arm in which the expansion arm is used and thus connected, attached and/or otherwise secured in place or position and thus removably and securedly connected, attached and/or otherwise secured either directly or indirectly to the first panel and the second panel which force-loads the hubs.

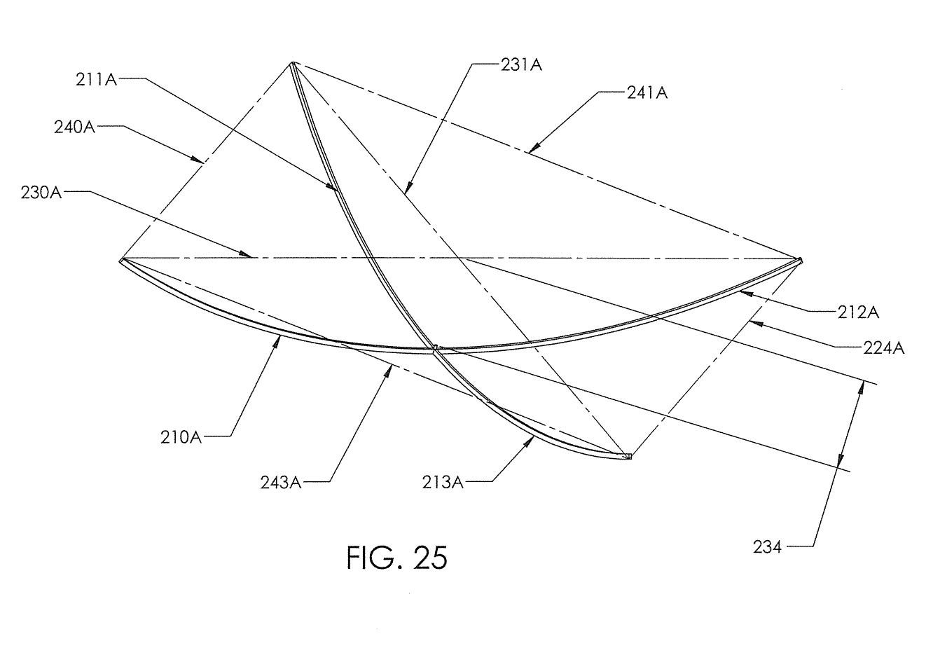

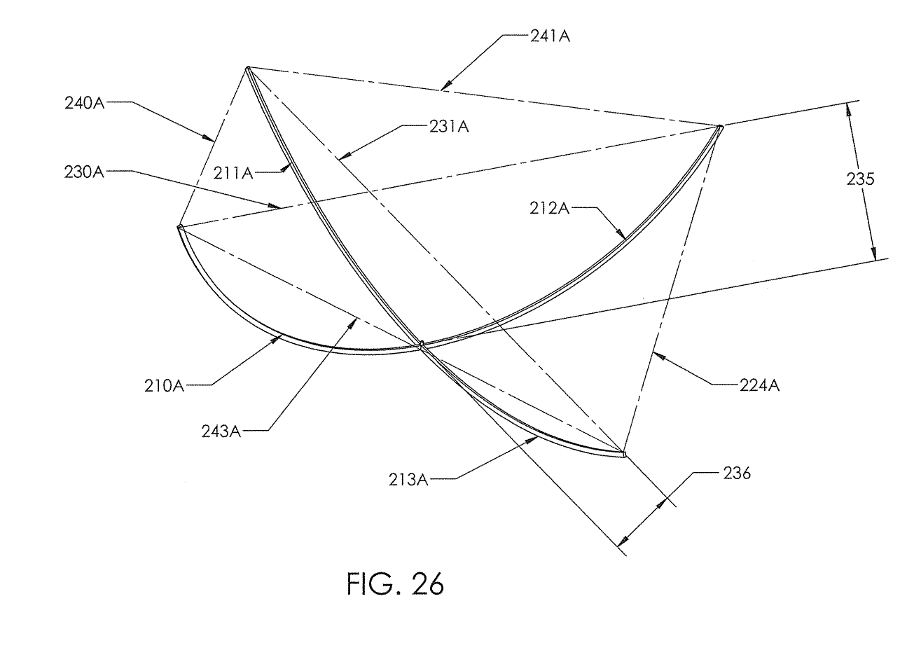

FIGS. 25 and 26 are used to better understand the meanings of the terms “symmetrical” and “asymmetrical” as used throughout this specification and in the claims. FIG. 25 shows support arms or rods 210A, 211A, 212A and 213A in a symmetrical condition or position, which is a no-load or unloaded condition or position of the support arms or rods, and in which the support arms or rods have similar arcs, similar chord lengths and similar distances 234, which is within planes 230A and 231A. FIG. 25 shows the unloaded or no-load position or condition in which the expansion arm of this invention is not used. FIG. 25 represents how conventional blind structures are configured or formed, particularly without the use of an expansion arm according to this invention.

FIG. 26 shows support arms or rods 210A, 211A, 212A and 213A in an asymmetrical condition or position, which is a with-load or loaded condition or position of the support arms or rods, and in which the support arms or rods do not have similar arcs, do not have similar chord lengths and do not have similar distances 235 and 236, which is within planes 230A and 231A. FIG. 26 shows the loaded or with-load position or condition in which the expansion arm of this invention is used. When the expansion arm of this invention is used, the support arms have an asymmetrical condition or position, which in some embodiments of this invention causes the hub to be force-loaded so that the hub and the support arms contact the panels and make the panels taut or put the panels into a taut or relatively tight condition.

While in the foregoing detailed description this invention has been described in relation to certain preferred embodiments thereof, and many details have been set forth for purposes of illustration, it will be apparent to those skilled in the art that this invention is susceptible to additional embodiments and that certain of the details described herein can be varied considerably without departing from the basic principles of this invention.

What is claimed is:

1. A method for constructing a blind structure, including the steps of:
forming a first hub structure with a first hub and at least one first support arm contacting a first panel;
forming a second hub structure with a second hub and at least one second arm contacting a second panel;
connecting the first hub structure to the second hub structure; and
positioning an expansion arm in a first position between and attaching the expansion arm to the first hub structure and the second hub structure and forcing the first hub to contact the first panel and forcing the second hub to contact the second panel.

2. The method according to claim 1, wherein in the first position the first hub structure is at a first distance from the second hub structure.

3. The method according to claim 1, wherein in the first position the first hub is forced toward and contacts the first panel and the second huh is forced toward and contacts the second panel.

4. The method according to claim 1, wherein a rear panel is connected to the first panel and the second panel.

5. The method according to claim 4, wherein positioning the expansion arm transforms the rear panel into a force-loaded taut condition.

6. The method according to claim 1, wherein positioning the expansion arm transforms the first panel and the second panel into a force-loaded taut condition.

7. The method according to claim 1, wherein the at least one first support arm is mounted in a rod pocket connected to the first panel.

8. The method according to claim 1, wherein positioning the expansion arm transitions each of the at least one first support arm and the at least one second support arm from a symmetrical condition to an asymmetrical condition.

9. The method according to claim 1, wherein positioning the expansion arm loads a first force in the first hub and maintains the first panel taut and loads a second force in the second hub and maintains the second panel taut.

10. A method for constructing a blind structure, including the steps of:
forming a first hub structure with a first hub contacting a first panel;
forming a second hub structure with a second hub contacting a second panel;
attaching the first hub structure to the second hub structure; and
securing the first panel to the second panel at a distance that forces the first hub to contact the first panel and forces the second hub to contact the second panel.

11. The method according to claim 10, wherein securing the first panel to the second panel loads the first hub to contact the first panel and maintain the first panel taut and loads the second hub to contact the second panel and maintain the second panel taut.

12. The method according to claim 10, wherein securing the first panel to the second panel transforms each of a first support arm and a second support arm from a symmetrical condition to an asymmetrical condition.

13. The method according to claim 10, wherein a rear panel is connected to the first panel and the second panel.

14. The method according to claim 10, wherein an expansion arm secures the first panel to the second panel.

15. A method for constructing a blind structure, including the steps of:
forming three panels of the blind structure;
forming three hub structures each corresponding to a different one of the panels;
forming a top of the blind structure; and
positioning a first panel and a second panel of the panels at a distance from each other and contacting a first hub of the hub structures to the first panel and contacting a second hub of the hub structures to the second panel.

16. The method according to claim 15, wherein in an interior of the blind structure the first hub contacts and maintains the first panel in a concave orientation in an outward direction from the interior to an outside of the blind structure.

17. The method according to claim 16, wherein in the interior the second hub contacts and maintains the second panel in the concave orientation in the outward direction, and a third hub of the hubs contacts and maintains a third panel of the panels in the concave orientation in the outward direction.

18. The method according to claim 15, wherein positioning the first panel and the second panel at the distance transforms each of a first support arm and a second support arm from a symmetrical arrangement to an asymmetrical arrangement.

19. The method according to claim 15, wherein an expansion arm is used to maintain the first panel and the second panel at the distance from each other.

20. The method according to claim 15, wherein connecting an expansion arm to and between the first panel and the second panel forms a fourth panel.
